(19) United States
(12) Patent Application Publication
(10) Pub. No.: US 2019/0291048 A1
(43) Pub. Date: Sep. 26, 2019

(54) BULK SEPARATION OF UNDESIRED COMPONENTS FROM GAS MIXTURES

(71) Applicants: Khalifa University of Science and Technology, Abu Dhabi (AE); Colorado School of Mines, Golden, CO (US)

(72) Inventors: Cornelis J. Peters, Abu Dhabi (AE); Carolyn Ann Koh, Golden, CO (US); Muhammad Naveed Khan, Golden, CO (US)

(21) Appl. No.: 16/303,089

(22) PCT Filed: May 18, 2017
(86) PCT No.: PCT/IB2017/052929

§ 371 Date: Nov. 19, 2018

Related U.S. Application Data
(60) Provisional application No. 62/339,231, filed on May 20, 2016.

(51) Int. Cl. B01D 53/78; B01D 53/52; B01D 53/62; C10L 3/10

(52) U.S. Cl. CPC B01D 53/78; B01D 53/52; B01D 53/62; C10L 3/103; C10L 3/104; C10L 2290/18; B01D 2256/245; B01D 2257/304; B01D 2257/504; B01D 2258/0283; C10L 3/108

(57) ABSTRACT

A method for separating undesired components from gas mixtures comprises the following steps of providing a gas mixture containing at least two gaseous components, wherein one component is an undesired component, feeding water to the gas mixture, forming a hydrate of the undesired component and a remaining gas mixture, wherein the hydrate is formed by spraying a combination comprising the water and the gas mixture, and separating the hydrate from the remaining gas mixture.

The present invention allows bulk removal of undesired components from industrial gas streams, e.g.: H₂S and/or CO₂ from natural gas, separation of CO₂ from flue gas, separation of CO₂ from the product stream of the water-gas shift reaction, etc.

### BACKGROUND

Currently, a wide range of chemical or physical solvents are used for the removal of undesired components such as H₂S and/or CO₂ from natural gas streams. The choice of the solvent strongly depends on the individual concentration of the undesired components in the gas streams.

There is a need for safe, reliable and economically feasible technologies to separate undesired components like H₂S and/or CO₂ from industrial gas mixtures. The natural gas industry is more and more dealing with elevated sour gas concentrations in, for instance, the Bab oil/gas field, where H₂S concentrations as high as 35% are met. The current sweetening technology is not dimensioned for such high H₂S concentrations.

### SUMMARY OF THE INVENTION

It is an object of the present invention to provide a method which is a clean technology, i.e. environmentally friendly, for removing undesired components from gas mixtures. It is a further object of the present invention to provide such a method which requires only moderate operating conditions, especially in terms of temperature and pressure. It is another object of the present invention to provide a method which enables bulk removal of undesired components from industrial gas streams, especially the removal of H₂S and/or CO₂ from natural gas mixtures. It is also an object of the present invention to provide such a method which is versatile and can similarly be used to separate CO₂ from gas mixtures, especially from flue gas or from the product stream of the water-gas shift reaction

In order to achieve one or more of the mentioned objects, the present invention provides a method for separating undesired components from gas mixtures comprising the following steps:

providing a gas mixture containing at least two gaseous components, wherein one component is an undesired component,

feeding water to the gas mixture,

forming a hydrate of the undesired component and a remaining gas mixture, wherein the hydrate is formed by spraying a combination comprising the water and the gas mixture, and

separating the hydrate from the remaining gas mixture.

In the above method, it is preferred that the undesired compound is selected from CO₂, H₂S, C₂H₆ and C₃H₈, wherein it is particularly preferred that the undesired compound is H₂S. It is further preferred that the undesired compound, especially the preferred undesired compound mentioned above, more preferably H₂S, forms 30 vol.-% or more of the gas mixture. In the context of the present invention, percentages are always vol.-%.

According to the present invention, it is particularly advantageous that the hydrate is formed by spraying a combination comprising the water and the gas mixture through a nozzle. In this context it is preferred that the nozzle is operated at a temperature below 6° C. and/or at a pressure below 30 bar. More preferably, the nozzle is operated at a temperature of 5.5° C. and at a pressure of 28 bar.

In an advantageous aspect of the invention, the hydrate is formed by spraying a combination comprising the water, the gas mixture and tetrahydrofuran.

It is further preferred that in the method according to the present invention the molar ratio of water to the gas mixture is in the range of 3:1 to 9:1, more preferably 6:1.

Gas hydrate separation technology offers a clean technology with only water and gas mixtures involved at moderate operating conditions in terms of temperature (T) and pressure (p).

The invention provides new technology preferably for a “model Bab field” gas stream with 70% CH₄ and 30% H₂S. Basically, the conversion of the feed gas into the hydrate phase causes a significant change in the composition of the gas. Separation of the gas hydrate phase leads to a gas stream with a significantly lower H₂S concentration. This aspect of the invention has a thermodynamic basis.

The second aspect of the invention is the kinetics of the hydrate formation. The kinetics of the hydrate formation is a slow process and, therefore, for an industrial application not very appealing. However, application of the advantageous spray technique allows hydrate formation instantaneously.

Both the merger of the thermodynamic and kinetic features are the basis for the invention. Simplification of current methods of removing of large concentrations of impurities from gases especially for example as between H₂S and CO₂.

The gas hydrate technology according to this invention is specifically suitable for bulk removal of H₂S/CO₂. The technology according to this invention has a much wider range of applications than H₂S removal only; also CO₂-removal from flue gas, separation of H₂ and CO₂, transforming production water from high to low salinity, etc. are contemplated.

The gas hydrate technology of this invention is safe and an excellent precursor for traditional gas sweetening processes.

### BRIEF DESCRIPTION OF THE DRAWINGS

The present invention will be described with reference to the accompanying drawings of which:

FIGS. 1(a) to 1(e) describe a H₂S+CH₄ system (mixture of H₂S+CH₄) processed according to the invention. The diagrams in the Figures show the mole fraction of gas former in hydrate phase.

FIG. 2 shows results for a system of 30% H₂S and 70% CH₄ which is particularly preferred according to the invention.

FIG. 3 describes in detail an exemplary treatment of the preferred system of 30% H₂S and 70% CH₄.

FIGS. 4(a) to 4(e) describe a CO₂+CH₄ system processed according to the invention. The diagrams in the Figures show the mole fraction of gas former in hydrate phase.

FIG. 5 shows results fora system of 10% CO₂ and 90% CH₄ which is particularly preferred according to the invention.

FIGS. 6(a) to 6(e) describe a N₂+CO₂ system processed according to the invention. The diagrams in the Figures show the mole fraction of gas former in hydrate phase.

FIG. 7 shows results for a system of 70% N₂ and 30% CO₂ which is particularly preferred according to the invention.

FIG. 8 shows a general principle of gas separation via gas hydrates as used in the present invention. Hydrate Former-1 (Hyd. Former-1) is stable at high Pressure at T, while Hydrate Former-2 (Hyd. Former-2) is stable at low Pressure at T.

FIG. 9 shows thermodynamic relationships for a mixture of 70% CH₄ and 30% H₂S.

FIG. 10 shows exemplary hydrate structures formed according to the invention.

FIG. 11 shows an exemplary experimental setup for hydrate formation from spraying.

FIG. 12 shows a process design for gas separation.

FIG. 13 shows the experimental results for two different feeds of 30% H₂S/70% CH₄ and 90% H₂S/10% CH₄, respectively, treated according to the process design of FIG. 12.

FIG. 14 shows a schematic process design for a mixture of e.g. 70% CH₄+30% H₂S.

FIG. 15 shows a schematic process design for a model flue gas consisting of 65% N₂+35% CO₂.

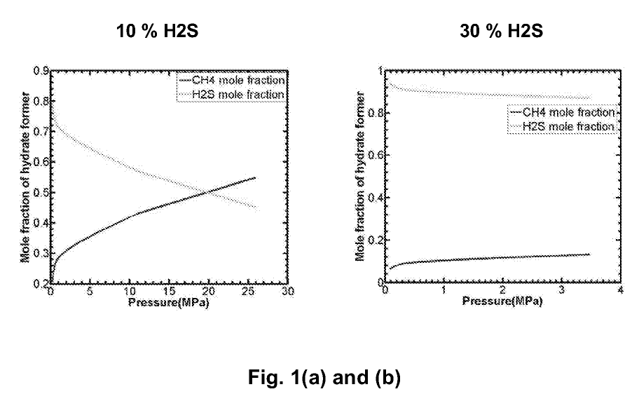

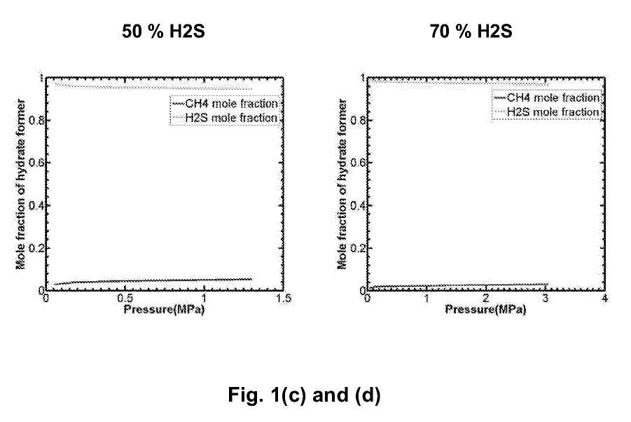

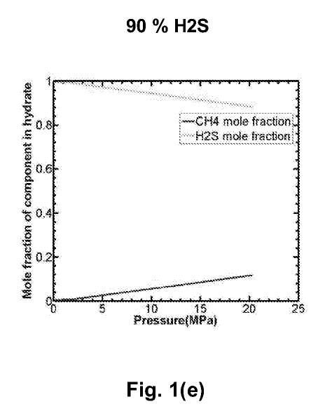

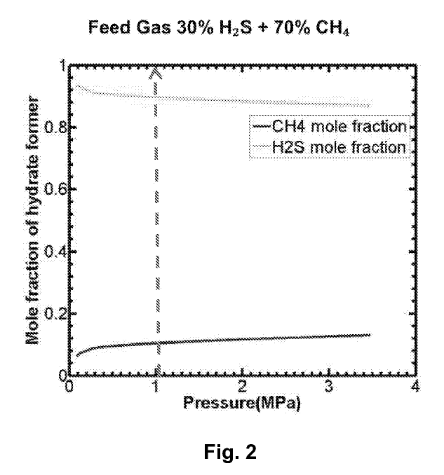

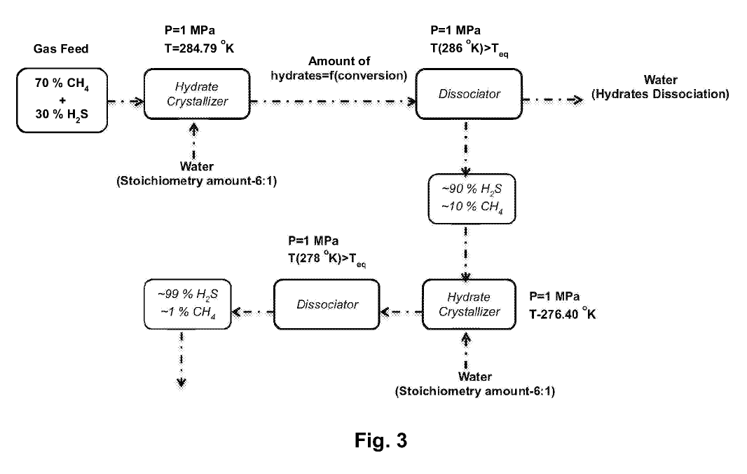

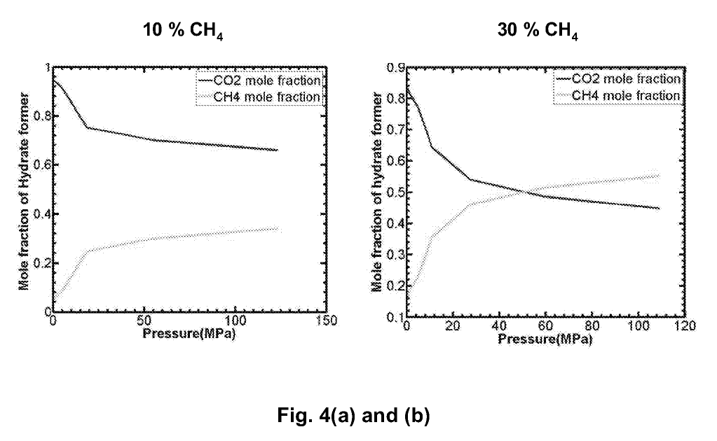

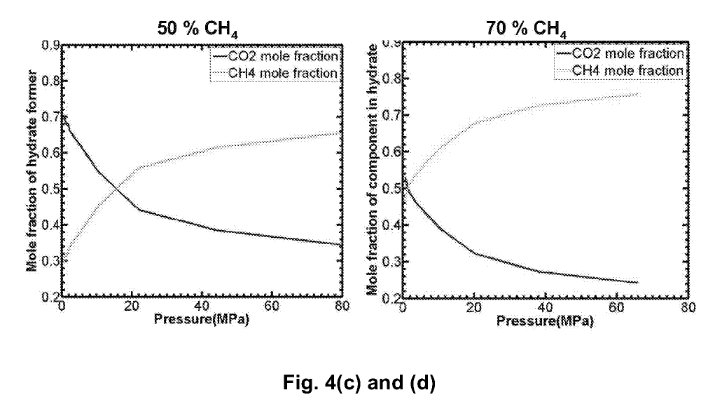

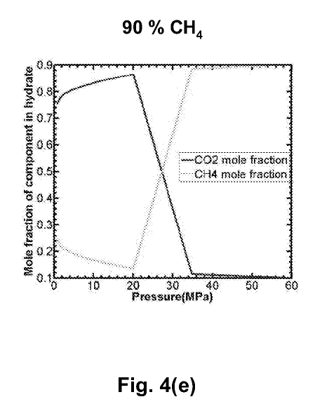

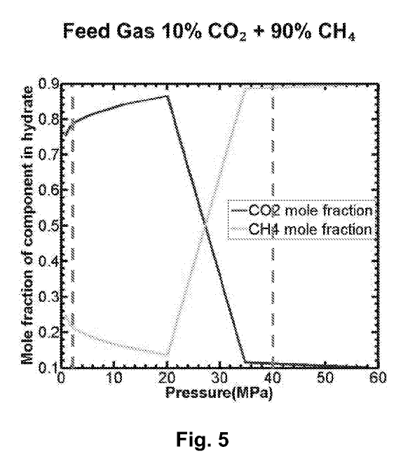

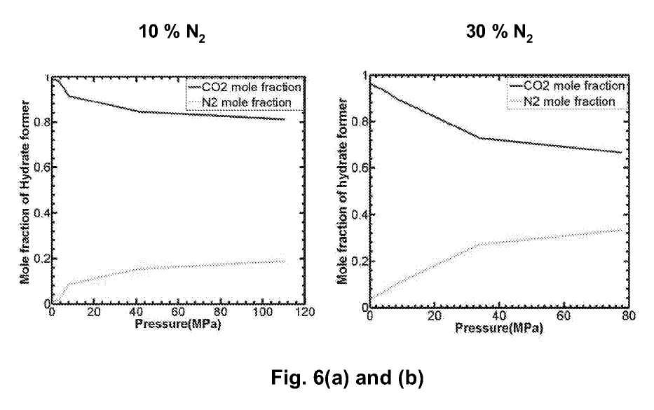

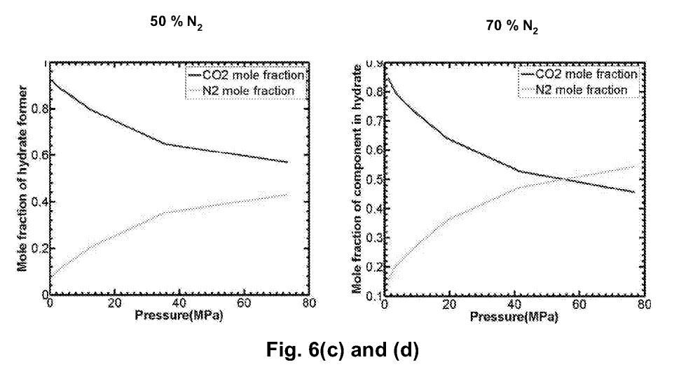

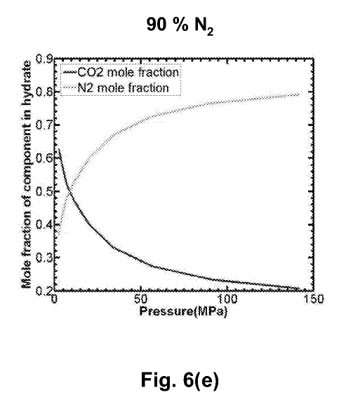

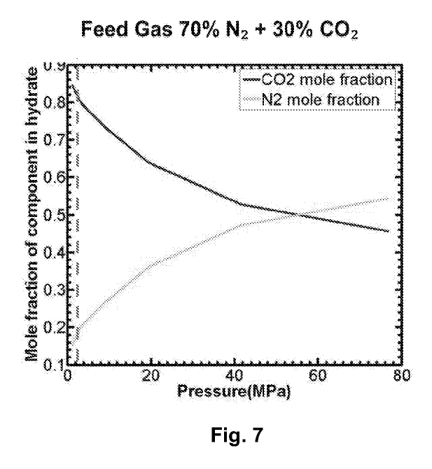

### DETAILED DESCRIPTION OF THE INVENTION

The present invention provides a new technology for e.g. a “model Bab field” gas stream with 70% CH₄ and 30% H₂S. Basically, the conversion of the feed gas into the hydrate phase causes a significant change in the composition of the gas. Decomposition of the gas hydrate phase leads to a gas stream with a significantly lower H₂S concentration. This aspect of the invention has a thermodynamic basis.

The second crucial aspect of the invention of the new technology is the kinetics of the hydrate formation. The kinetics of the hydrate formation is a slow process and, therefore, for an industrial application not very appealing. However, application of a spray technique allows hydrate formation instantaneously.

A hydrate according to this invention is a compound in which water molecules are chemically bound to another compound or an element. Such hydrates are typically crystalline as measurable by X-ray diffraction, for example Powder X-Ray Diffraction (PXRD).

For example, H₂S forms hydrates under certain conditions. The known technologies seem to be less useful where H₂S is present in high concentrations of e.g. 30% or more. The invention exploits inter alia the fact that H₂S is a strong hydrate former. After separating the hydrate phase from the remaining gas phase, the H₂S concentration in the desired gaseous product can be significantly reduced, e.g. from 30% or more to 1% or less. In the context of this invention, percentages are always volume percentages (vol.-%).

Further, the hydrate formation is slow which makes it less useful for large scale productions. In order to achieve a rapid hydrate formation, the invention uses a spray technique. The small size of the droplets formed by spraying contributes to a faster hydrate formation.

CH₄ was used in some of the experiments related to this invention. The present invention is especially directed at the removal of undesired components from natural gas as the treated gas mixture. Natural gas in the sense of this invention comprises at least one alkane, preferably methane. Major contaminants in raw natural gas that also may form gas hydrate at the same thermodynamic conditions as CO₂ and H₂S are C₂H₆ and C₃H₈. Their common concentration ranges (in volume %) of their presence in raw natural gas are given below. Higher or lower bounds are possible, depending on the location and type of the source:

C₂H₆: 1.5-7.0
C₃H₈: 0.1-1.5

### N₂: 0.2-5.5

Although N₂ is a hydrate former as well, the pressure at which this hydrate will be formed is significantly higher than that of CO₂ and H₂S. Therefore, in the separation process interference by the formation of N₂ hydrate will not occur.

Aromatic compounds may form hydrates as well. However, in general their concentration in natural gas is very low and, therefore, interference of the separation process by hydrate formation caused by aromatics is unlikely to occur.

In other experiments related to this invention flue gas was used. Model flue gas is formed by 65% N₂ and 35% CO₂.

A typical composition of gas-fired flue gas, which is useful in the present invention, is 7.4-7.7% CO₂, 14.6% H₂O, approx. 4.45% O₂, 200-300 ppm CO, 60-70 ppm NO₂, and 73-74% N₂.

A typical composition of coal-fired flue gas, which is useful in the present invention, is 12.5-12.8% CO₂, 6.2% H₂O, approx. 4.4% O₂, 50 ppm CO, 420 ppm NOx, 420 ppm SO₂, and 76-77% N₂.

Another gas which can be advantageously treated according to the invention is the water-gas shift reaction product. At the exit of the water-gas-shift process a gas composition of 20% CO₂ and 80% H₂ is typically found. Minor amounts of CO and CH₄ might be present.

Separation of a mixture of 30% H₂S+70% CH₄ (mimics Bab gas field): this process preferably takes place at a constant pressure of 10 bar. The lowest temperature during the process is 276.40 K (exit) and the highest 284.79 K (entrance).

In addition, other systems for separation are also feasible for the present invention:

i) 70% N₂+30% CO₂ (flue gas), average temperature over the process is 274K. As can be seen, the separation can take place at relatively low pressures.
ii) 90% CH₄+10% CO₂ (natural gas), average temperature over the process is 274K. As can be seen, the separation can take place at relatively low pressures.

With respect to the amount of water added for forming the hydrates, it is advantageous that the molar ratio water/gas is in the range of 3:1 to 9:1 and is more preferably stoichiometric, i.e. 6:1 so that all available hydrate cavities are occupied.

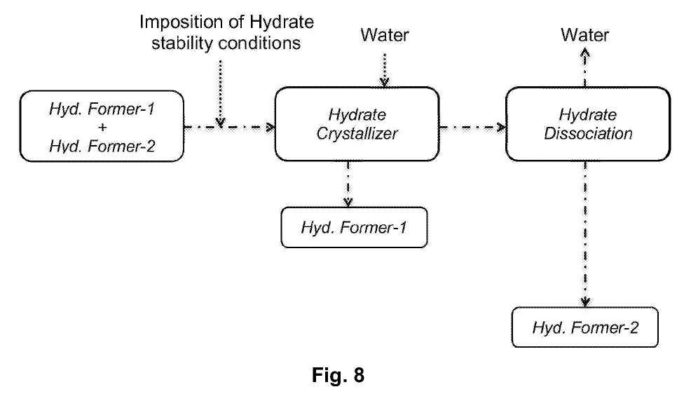

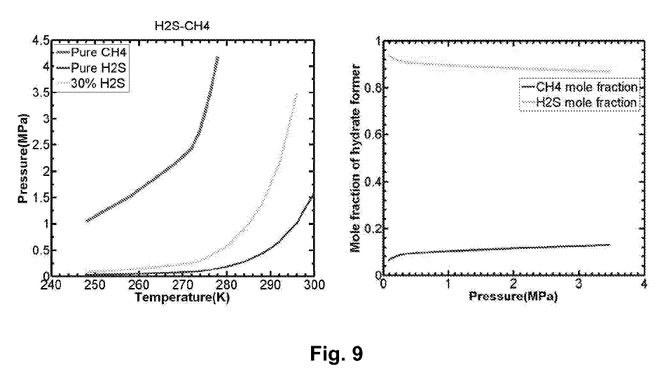

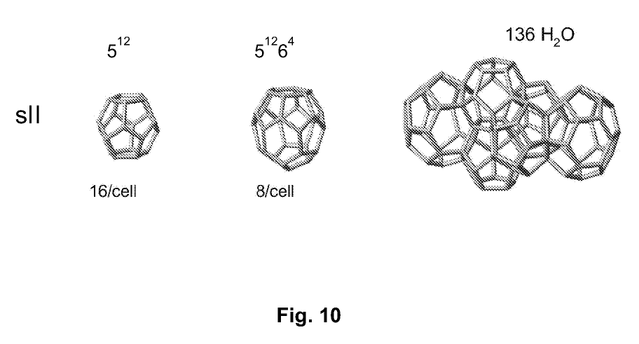

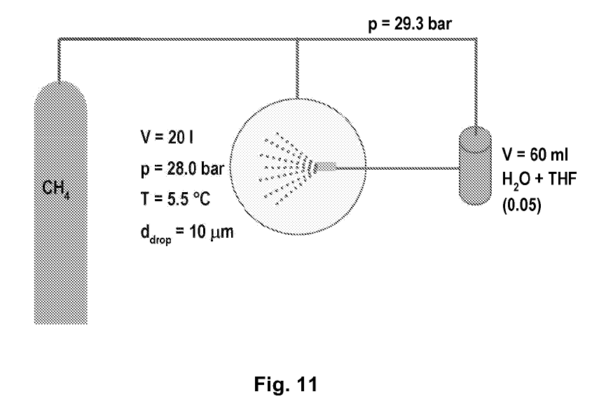

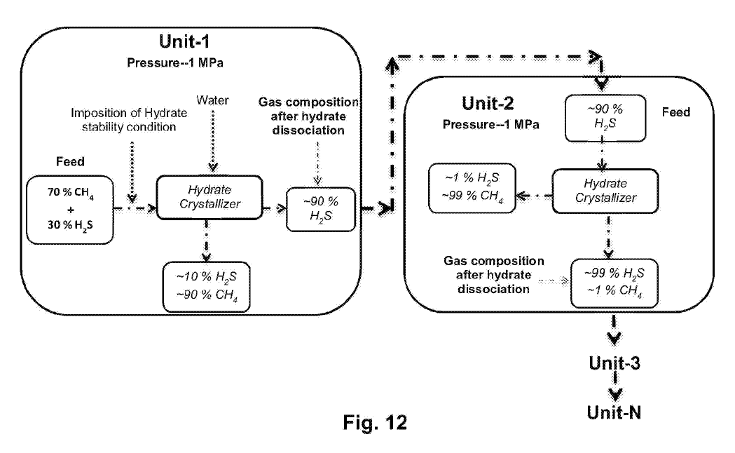

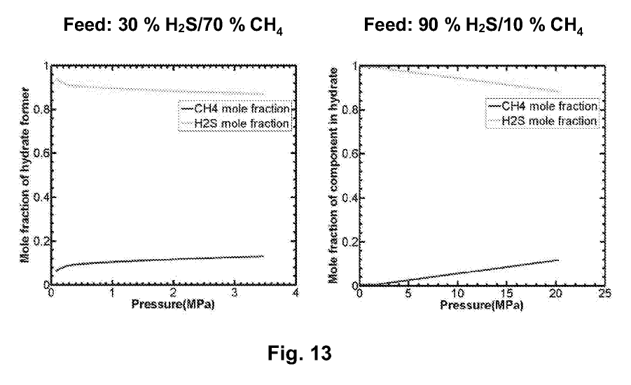

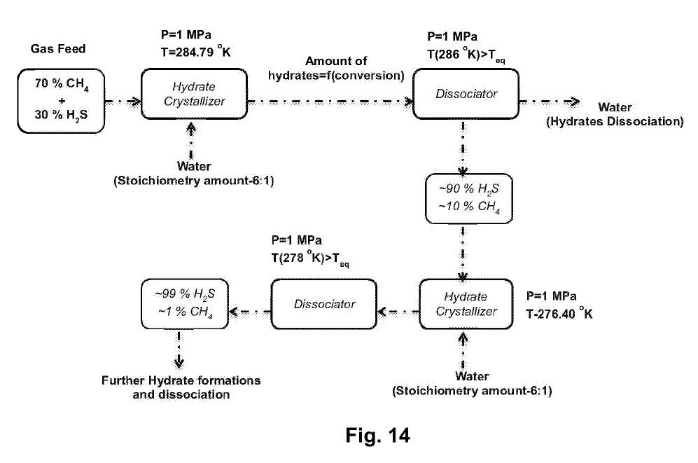

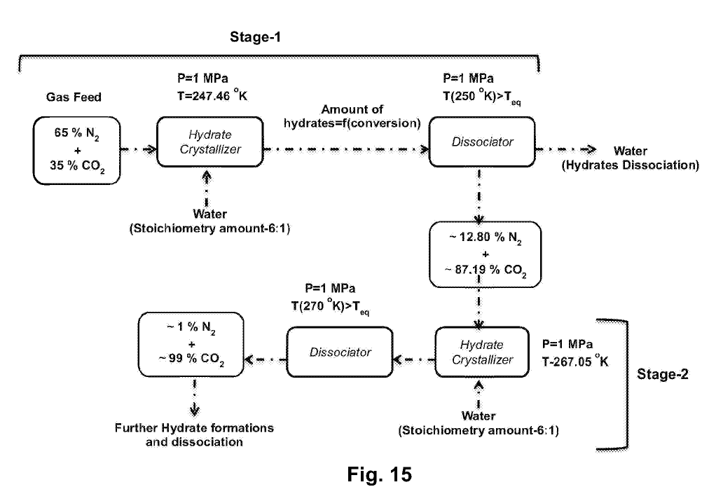

After conversion of the raw gas into hydrate, followed by separation of the hydrate phase and decomposition of the hydrate phase, the gas released from the hydrate has a completely different composition compared to the original raw gas. This is the basis of the separation and also shown in the attached FIGS., especially in FIGS. 8, 14 and 15. The hydrate is formed as a slurry from which the superfluous liquid phase can preferably be separated. Standard technology exists for this, e.g. centrifugal forces.

One experimental set-up for the spraying step, which is a particularly preferred step of forming the hydrates, includes p, T parameters (pressure, temperature). Specifically T=5.5° C. and p(nozzle)=29.3 bar. This setup proved that the spraying technique is capable to strongly enhance the rapid formation of hydrate. In the experimental setup a nozzle was installed that could produce droplets of 10 μm (average size). That is, the nozzle was specially designed to produce droplets having an average size of 10 μm.

From visual observation it could be seen that with the selected nozzle and pressure the aqueous phase was injected at high speed into the high-pressure vessel and hydrate was formed instantaneously. This was the major breakthrough in this experiment.

In the method of the present invention, a mixture containing H₂O and THF (tetrahydrofuran) can preferably be used for forming the hydrates via a spraying step. THF is a so-called hydrate promoter and causes that the hydrate is formed at relatively low pressures. THF is not essential but lower pressures makes the capital investment in this technology much lower.

1. A method for separating undesired components from gas mixtures comprising the following steps:
providing a gas mixture containing at least two gaseous components, wherein one component is an undesired component,
feeding water to the gas mixture,
forming a hydrate of the undesired component and a remaining gas mixture, wherein the hydrate is formed by spraying a combination comprising the water and the gas mixture, and
separating the hydrate from the remaining gas mixture.

2. Method according to claim 1 wherein the undesired compound is selected from CO₂, H₂S, C₂H₆ and C₃H₈.

3. Method according to any of the preceding claims wherein the undesired compound is H₂S.

4. Method according to any of the preceding claims wherein the undesired compound forms 30 vol.-% or more of the gas mixture.

5. Method according to any of the preceding claims wherein the hydrate is formed by spraying a combination comprising the water and the gas mixture through a nozzle.

6. Method according to claim 5 wherein the nozzle is operated at a temperature below 6° C.

7. Method according to claim 5 or 6 wherein the nozzle is operated at a pressure below 30 bar.

8. Method according to claim 5 wherein the nozzle is operated at a temperature of 5.5° C. and at a pressure of 28 bar.

9. Method according to any of the preceding claims wherein the hydrate is formed by spraying a combination comprising the water, the gas mixture and tetrahydrofuran.

10. Method according to any of the preceding claims wherein molar ratio of water to the gas mixture is in the range of 3:1 to 9:1, preferably 6:1.
